(19) United States
(12) Patent Application Publication
(10) Pub. No.: US 2009/0326183 A1
(43) Pub. Date: Dec. 31, 2009

(54) BRANCHED POLYCARBONATE-POLYSILOXANE COPOLYMERS AND PROCESSES FOR PRODUCING THE SAME

(76) Inventors: Laura G. Schultz, Evansville, IN (US); James A. Mahood, Evansville, IN (US); Brian D. Mullen, Plymouth, MN (US)

Correspondence Address: SABIC - LEXAN;SABIC Innovative Plastics - IP Legal, ONE PLASTICS AVE., PITTSFIELD, MA, 01201-3697, US

(21) Appl. No.: 12/164,975

(22) Filed: Jun. 30, 2008

(51) Int. Cl. C08G 64/24

(52) U.S. Cl. 528/196

(57) ABSTRACT

Methods for making a branched polycarbonate-polysiloxane copolymer are provided. An interfacial mixture comprising water, an organic solvent, a polyhydric branching agent, a non-siloxane-containing dihydroxy compound, an endcapping agent, a phase transfer catalyst, and a base is formed. The base and the branching agent are dissolved in the mixture before the non-siloxane-containing dihydroxy compound is added and the interfacial mixture has a basic pH. A first carbonate precursor is added to the interfacial mixture while maintaining the pH at from about 3 to about 9 to form a branched polycarbonate mixture. Next, the pH is increased to from about 8 to about 13 and a siloxane oligomer is added to the branched polycarbonate mixture. The branched polycarbonate mixture is then reacted to form the branched polycarbonate-polysiloxane copolymer. The resulting branched copolymer contains 20 ppm or less of residual chloride, is transparent, has improved flow properties, and has good flame retardance at thin wall thicknesses.

### CROSS-REFERENCE TO RELATED APPLICATIONS

This application is related to U.S. patent application Ser. No. ______, entitled “Branched Polycarbonates And Processes For Producing The Same,” filed Jun. 30, 2008 (229309-1, SABI 2 00041). The entirety of that disclosure is hereby fully incorporated by reference.

### BACKGROUND

The present disclosure relates to processes and intermediates for preparing branched polycarbonate-polysiloxane copolymer compositions. In this regard, the disclosure relates to the interfacial synthesis of branched polycarbonate-polysiloxane copolymers and to compositions produced by such processes. Also included are articles, such as molded, extruded, thermoformed, etc. articles, formed from these compositions.

Polycarbonates (PC) are synthetic thermoplastic resins derived from bisphenols and phosgene, or their derivatives. They are linear polyesters of carbonic acid and can be formed interfacially from reaction of dihydroxy compounds with phosgene or via ester interchange by reaction of dihydroxy compounds with a carbonate diester.

The desired properties of polycarbonates include clarity or transparency (i.e. 90% light transmission or more), high impact strength and toughness, heat resistance, weather and ozone resistance, good ductility, being combustible but self-extinguishing, good electrical resistance, noncorrosive, nontoxic, etc. They are useful for forming a wide array of products, such as by molding, extrusion, and thermoforming processes. Branched polycarbonates, in some instances, can produce enhanced, or more desirable, characteristics over conventional linear polycarbonates. Polycarbonate-polysiloxane copolymers typically have enhanced ductility, increased impact strength, and better flame retardance than polycarbonate homopolymers.

A homopolycarbonate is generally formed from the polymerization of a dihydroxy compound such as bisphenol-A. To form a branched polycarbonate, a branching agent which has at least three functional groups is added to the mixture. Exemplary branching agents include trimellitic trichloride and 1,1,1-tris(hydroxyphenyl)ethane (THPE). Typically, the branching agent is added during the reaction of the dihydroxy compound with phosgene. Because each functional group can react with a dihydroxy compound, branching occurs. However, one problem that arises from the use of a branching agent is high residual content of ionic groups, such as chlorides. High chloride content can adversely impact melt stability, hydrolytic stability, and possibly the color and/or transparency of articles molded from the polycarbonate.

It is desirable to generate new processes that allow the formation of branched polycarbonate-polysiloxane materials without high residual ionic content. Included therein are processes for producing relatively transparent, flame-retardant polycarbonate copolymers capable of providing good flame retardance characteristics in thin wall constructions.

### BRIEF DESCRIPTION

Disclosed, in various embodiments, are methods for producing branched polycarbonate-polysiloxane copolymers. Also disclosed are the resulting branched polycarbonate-polysiloxane copolymers produced by these methods and articles formed therefrom.

Disclosed in embodiments is a method for making a branched polycarbonate-polysiloxane copolymer, comprising:
forming an interfacial mixture comprising water, a substantially water-immiscible organic solvent, a polyhydric branching agent, a non-siloxane-containing dihydroxy compound, an endcapping agent, a phase transfer catalyst, and a base, wherein the base and the branching agent are dissolved in the mixture before the non-siloxane-containing dihydroxy compound is added to the mixture and wherein the interfacial mixture has a basic pH;
reacting the interfacial mixture by adding a first carbonate precursor to the interfacial mixture while maintaining the pH at from about 3 to about 9 to form a branched polychloroformate mixture containing at least 1.5 mole percent of the polyhydric branching agent;
increasing the pH to from about 8 to about 13 and adding a siloxane oligomer and a tertiary amine catalyst to the branched polychloroformate mixture;
reacting the branched polychloroformate mixture; and
optionally adding a second carbonate precursor to the branched polychloroformate mixture while maintaining the pH at about 8 to about 13 during the reacting of the branched polychloroformate mixture;
to form the branched polycarbonate-polysiloxane copolymer, wherein the copolymer contains 20 ppm or less of residual chloride.

The organic solvent is desirably methylene chloride or a chlorine-containing aromatic solvent.

The polyhydric branching agent may be selected from the group consisting of 1,1,1-tris(4-hydroxyphenyl)ethane, 1,3,5-tris(4-hydroxyphenyl)benzene, tris(4-hydroxyphenyl)methane, 1,1,2-tris(4-hydroxyphenyl)propane, 1,3,5-trihydroxybenzene, m-terphenyltriol, trisphenol PA, trisphenol TC, and trisphenol OC-HAP.

The endcapping agent may be 4-cyanophenol, p-cumyl phenol, phenol, or 4-t-butylphenol. The first catalyst (i.e. the catalyst added during the formation of the interfacial mixture) is a phase transfer catalyst, and the second catalyst (added subsequent to the formation of the branched polychloroformate mixture) may be any amine catalyst such as a triethylamine. The carbonate precursor may be phosgene.

The first carbonate precursor can added to the mixture at more than one and less than five addition rates.

The method of claim 1, wherein the branched polycarbonate-polysiloxane copolymer can contain at least 1.5 mole percent of the polyhydric branching agent

The branched polycarbonate-polysiloxane copolymer has a weight average molecular weight of about 20,000 or higher; a melt viscosity of 210 Pa·sec or lower when measured at 1500 sec⁻¹ according to ISO 11443; and/or a haze level of 10 percent or less when measured according to ASTM D1003.

An article molded from the branched polycarbonate-polysiloxane copolymer can attain UL94 V0 performance at a thickness of 1.5 or 1.0 millimeters.

The method may further comprise separating the branched polycarbonate-polysiloxane copolymer from the interfacial mixture.

Also disclosed in embodiments is a branched polycarbonate-polysiloxane copolymer having a weight average molecular weight of 28,000 or higher; and a melt viscosity of 210 Pa·sec or lower when measured at 1500 sec⁻¹ according to ISO 11443.

The branched polycarbonate-polysiloxane copolymers formed using such processes, as well as articles formed from such branched copolymers, are also disclosed. These and other non-limiting characteristics are more particularly described below.

### DETAILED DESCRIPTION

Numerical values in the specification and claims of this application, particularly as they relate to polymer compositions, reflect average values for a composition that may contain individual polymers of different characteristics. Furthermore, unless indicated to the contrary, the numerical values should be understood to include numerical values which are the same when reduced to the same number of significant figures and numerical values which differ from the stated value by less than the experimental error of conventional measurement techniques of the type described in the present application to determine the value.

The singular forms “a,” “an,” and “the” include plural referents unless the context clearly dictates otherwise. All ranges disclosed herein are inclusive of the recited endpoint and independently combinable (for example, the range of “from 2 grams to 10 grams” is inclusive of the endpoints, 2 grams and 10 grams, and all the intermediate values).

The modifier “about” used in connection with a quantity is inclusive of the stated value and has the meaning dictated by the context (for example, it includes at least the degree of error associated with the measurement of the particular quantity).

Compounds are described using standard nomenclature. For example, any position not substituted by any indicated group is understood to have its valency filled by a bond as indicated, or a hydrogen atom. A dash (“-”) that is not between two letters or symbols is used to indicate a point of attachment for a substituent. For example, the aldehyde group —CHO is attached through the carbon of the carbonyl group.

The term “aliphatic” refers to a linear or branched array of atoms that is not cyclic and has a valence of at least one. Aliphatic groups comprise at least one carbon atom and may include heteroatoms such as nitrogen, sulfur, silicon, selenium and oxygen. Aliphatic groups may be substituted or unsubstituted. Exemplary aliphatic groups include, but are not limited to, methyl, ethyl, isopropyl, isobutyl, hydroxymethyl (—CH₂OH), mercaptomethyl (—CH₂SH), methoxy, methoxycarbonyl (CH₃OCO—), nitromethyl (—CH₂NO₂), and thiocarbonyl.

The term “alkyl” refers to a linear or branched array of atoms that is composed exclusively of carbon and hydrogen. Alkyl groups may be saturated or unsaturated; in other words, they may be alkanes, alkenes, or alkynes. Exemplary alkyl groups include, but are not limited to, methyl, ethyl, and isopropyl.

The term “aromatic” refers to an array of atoms having a valence of at least one and comprising at least one aromatic group. The array of atoms may include heteroatoms such as nitrogen, sulfur, selenium, silicon and oxygen. The aromatic group may also include nonaromatic components. For example, a benzyl group is an aromatic group that comprises a phenyl ring (the aromatic component) and a methylene group (the nonaromatic component). Exemplary aromatic groups include, but are not limited to, phenyl, pyridyl, furanyl, thienyl, naphthyl, biphenyl, and benzyl.

The terms “cycloalkyl” and “cycloaliphatic” refer to an array of atoms which is cyclic but which is not aromatic. The cyclic portion of the cycloaliphatic group may include heteroatoms such as nitrogen, sulfur, selenium, silicon and oxygen, while the cyclic portion of the cycloalkyl group is composed exclusively of carbon and hydrogen. A cycloaliphatic group may comprise one or more noncyclic components. For example, a cyclohexylmethyl group (C₆H₁₁CH₂) is a cycloaliphatic functionality, which comprises a cyclohexyl ring (the array of atoms which is cyclic but which is not aromatic) and a methylene group (the noncyclic component). Exemplary cycloaliphatic groups include, but are not limited to, cyclopropyl, cyclobutyl, 1,1,4,4-tetramethylcyclobutyl, piperidinyl, and 2,2,6,6-tetramethylpiperydinyl.

The term “hydrocarbon” refers to an array of atoms composed exclusively of carbon and hydrogen. A hydrocarbon group may also be an alkyl group, an aromatic group, or a cycloalkyl group, and may include combinations of these groups.

When used in reference to pH, the term “greater” with reference to a pH value means that the pH range is more basic. The term “less” means that the pH range is more acidic. For example, “a pH of 6 or greater” includes pHs of 7, 8, 9, etc., while “a pH of 6 or less” includes pHs of 5, 4, 3, etc.

The branched polycarbonate-polysiloxane copolymers of the present disclosure are prepared from an initial interfacial mixture comprising water, a substantially water-immiscible organic solvent, a non-siloxane-containing dihydroxy compound, a polyhydric branching agent, an endcapping agent, a phase transfer catalyst, and a base, wherein the initial interfacial mixture has a basic pH. In particular embodiments, the initial interfacial mixture has a pH of 9 or greater. As described further herein, the base and polyhydric branching agent are dissolved in the mixture (the water and organic solvent) before the non-siloxane-containing dihydroxy compound is added to the mixture.

The water and substantially water-immiscible organic solvent allow interfacial polymerization to occur at their interfaces. The term “substantially water-immiscible” means that the organic solvent will not mix with water in any proportion to form a homogeneous solution. Suitable organic solvents are known in the art. Exemplary organic solvents include methylene chloride, chloroform, chlorobenzene, and other chlorine-containing aromatic solvents. In specific embodiments, the organic solvent used is methylene chloride.

Dihydroxy compounds generally have the formula HO—R¹—OH, which includes dihydroxy compounds of formula (1)

HO-A¹-Y¹-A²-OH (1)

wherein each of A¹ and A² is a monocyclic divalent aryl radical and Y¹ is a bridging radical having one or two atoms that separate A¹ from A². In an exemplary embodiment, one atom separates A¹ from A². Illustrative non-limiting examples of Y¹ include —O—, —S—, methylene, cyclohexyl-methylene, 2-[2.2.1]-bicycloheptylidene, isopropylidene, and adamantylidene. In particular, the bridging radical Y¹ may be a hydrocarbon group or a saturated hydrocarbon group such as methylene, cyclohexylidene, or isopropylidene. Also included are bisphenol compounds of general formula (2):

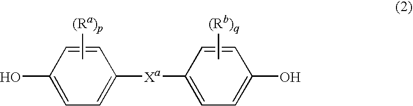

wherein R^{a} and R^{b} each represent a monovalent hydrocarbon group and may be the same or different; p and q are each independently integers of 0 to 4; and X^{a} represents one of the groups of formula (3):

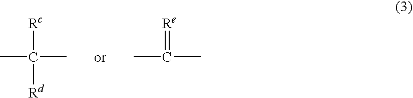

wherein R^{c} and R^{d} each independently represent a hydrogen atom or a monovalent linear or cyclic hydrocarbon group and R^{e} is a divalent hydrocarbon group.

Other bisphenols containing substituted or unsubstituted cyclohexane units can be used, for example bisphenols of formula (4):

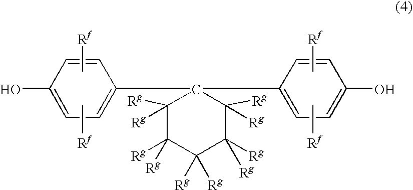

wherein each R^{f} is independently hydrogen or C₁₋₁₂ alkyl; and each R^{g} is independently hydrogen or C₁₋₁₂ alkyl. The substituents may be aliphatic or aromatic, straight chain, cyclic, bicyclic, branched, saturated, or unsaturated. Such cyclohexane-containing bisphenols, for example the reaction product of two moles of a phenol with one mole of a hydrogenated isophorone, are useful for making polycarbonate polymers with high glass transition temperatures and high heat distortion temperatures.

Other useful dihydroxy compounds having the formula HO—R¹—OH include aromatic dihydroxy compounds of formula (5):

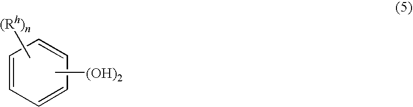

wherein each R^{h} is independently a C₁₋₁₀ alkyl group, and n is 0 to 4.

In specific embodiments, the dihydroxy compound may have the structure of Formula (I):

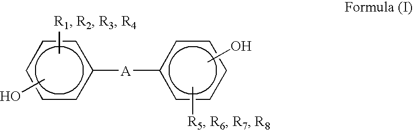

wherein R₁ through R₈ are each independently selected from hydrogen, nitro, cyano, C₁-C₂₀ alkyl, C₁-C₂₀ aliphatic, C₄-C₂₀ cycloalkyl, and C₆-C₂₀ aryl; and A is selected from a bond, —O—, —S—, —SO₂—, C₁-C₁₂ alkyl, C₆-C₂₀ aromatic, C₁-C₂₀ aliphatic, and C₆-C₂₀ cycloaliphatic.

In specific embodiments, the dihydroxy compound of Formula (I) is 2,2-bis(4-hydroxyphenyl) propane (i.e. bisphenol-A or BPA). Other illustrative compounds of Formula (I) include:
2,2-bis(4-hydroxy-3-methylphenyl)propane;
2,2-bis(4-hydroxy-3-isopropylphenyl)propane;
2,2-bis(3-t-butyl-4-hydroxyphenyl)propane;
2,2-bis(3-phenyl-4-hydroxyphenyl)propane;
1,1-bis(4-hydroxyphenyl)cyclohexane;
4,4′dihydroxy-1,1-biphenyl;
4,4′-dihydroxy-3,3′-dimethyl-1,1-biphenyl;
4,4′-dihydroxy-3,3′-dioctyl-1,1-biphenyl;
4,4′-dihydroxydiphenylether;
4,4′-dihydroxydiphenylthioether; and
1,3-bis(2-(4-hydroxyphenyl)-2-propyl)benzene.

The polyhydric branching agent of the present disclosure may be any branching agent having at least three hydroxyl groups for branching. For example, the branching agent may be a polyphenolic compound of the following formula (6):

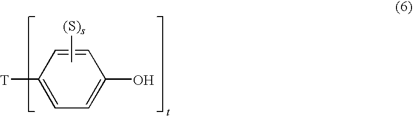

wherein T is a C₁₋₂₀ hydrocarbon group; each S is independently a halogen, C₁₋₃ alkyl group, C₁₋₃ alkoxy group, C₇₋₁₂ arylalkyl, alkylarlyl, or nitro group; each s is independently 0 to 4; and t is an integer of 3 or more. Typically, t will be 3 or 4. In particular embodiments, T is ethyl, t is 3, and each s is zero; this compound is 1,1,1-tris(4-hydroxyphenyl)ethane, or THPE. Other branching agents described by formula (6) include 1,3,5-tris(4-hydroxyphenyl)benzene, tris(4-hydroxyphenyl)methane, 1,1,2-tris(4-hydroxyphenyl)propane, trisphenol PA, 1,3,5-tris((4-hydroxyphenyl)isopropyl)benzene (trisphenol TC), and 1,1,1-tris(3-methyl-4-hydroxyphenyl)ethane (trisphenol OC-HAP). In particular, some trisphenols that are poorly soluble in methylene chloride and poorly soluble in water can be solubilized by the addition of a base, such as NaOH. Other exemplary polyhydric branching agents include 1,3,5-trihydroxybenzene and m-terphenyltriol. Other polyphenolic compounds that are poorly soluble in water and methylene chloride may also be used, such as those that may be disclosed in U.S. Reissue Patent No. RE27,682.

The molar ratio of the dihydroxy compound to the polyhydric branching agent generally determines the amount of branching present in the resulting branched polycarbonate-polysiloxane copolymer. The relative amount of branching agent will depend on a number of considerations, such as the amount of endcapping agent and the desired molecular weight of the branched copolymer. In embodiments, the molar ratio of dihydroxy compound to the polyhydric branching agent may be from about 10 to about 70. In more specific embodiments, the molar ratio of dihydroxy compound to the polyhydric branching agent 98.5:1.5 or greater, desirably about 97:3.

Any endcapping agent may generally be used. For example, p-cumyl phenol, phenol, and 4-t-butylphenol may be used as the endcapping agent. However, in specific embodiments, the endcapping agent is a cyanophenol of formula (7):

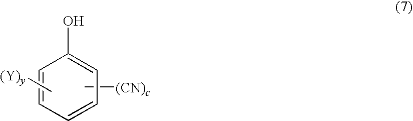

wherein each Y is independently a C₁₋₃ alkyl group, C₁₋₃ alkoxy group, C₇₋₁₂ arylalkyl, alkylaryl, or nitro group; y is 0 to 4; c is 1 to 5; and 1≦y+c≦5. Specific cyanophenols include 4-cyanophenol and 3,5-dicyanophenol. The endcapping agent is used to control the molecular weight of the resulting branched copolymer. In specific embodiments, the molar ratio of dihydroxy compound to endcapping agent may be from about 94:6 to about 80:20.

Suitable catalysts for the interfacial polymerization reaction are generally known to those in the art. They include aliphatic amines, particularly tertiary amine catalysts such as triethylamine. Generally, trialkylamines are especially preferred, wherein the alkyl groups contain up to about 4 carbon atoms. Another suitable catalyst is a phase transfer catalyst. Among the phase transfer catalysts that may be used are catalysts of the formula (R³)₄Q⁺X, wherein each R³ is the same or different, and is a C₁₋₁₀ alkyl group; Q is a nitrogen or phosphorus atom; and X is a halogen atom or a C₁₋₈ alkoxy group or C₆₋₁₈ aryloxy group. Useful phase transfer catalysts include, for example, [CH₃(CH₂)₃]₄NX, [CH₃(CH₂)₃]₄PX, [CH₃(CH₂)₅]₄NX, [CH₃(CH₂)₆]₄NX, [CH₃(CH₂)₄]₄NX, CH₃[CH₃(CH₂)₃]₃NX, and CH₃[CH₃(CH₂)₂]₃NX, wherein X is Cl⁻, a C₁₋₈ alkoxy group or a C₆₋₁₈ aryloxy group. Combinations of such catalysts are also effective. An effective amount of catalyst may be about 0.1% by weight to about 10% by weight based on the weight of dihydroxy compound in the initial interfacial mixture. In more specific embodiments, an effective amount of catalyst may be about 0.5% by weight to about 2% by weight based on the weight of dihydroxy compound in the initial interfacial mixture. In some embodiments, the catalyst may comprise a mixture of methyl tributylammonium chloride and sodium gluconate.

To provide a basic pH to the interfacial mixture, any strong base may be used. A base is any substance that can accept protons and generally, when dissolved in water, gives a solution with a pH of greater than 7. Exemplary bases include sodium hydroxide and potassium hydroxide. In particular, the polyhydric branching agent is exposed to a basic pH prior to being exposed to the non-siloxane-containing dihydroxy compound. Put another way, the polyhydric branching agent and the base are added to the initial interfacial mixture and dissolved before adding the non-siloxane-containing dihydroxy compound to the initial interfacial mixture. It has been discovered that adding the ingredients in this order significantly reduces the ionic content of the resulting branched copolymer. In particular, the branched copolymer may contain 20 ppm or less of residual chloride. The polyhydric branching agent and base can be added first to the water and organic solvent in the interfacial mixture and dissolved. Alternatively, the polyhydric branching agent and base can be dissolved in an aqueous solution, then added to the interfacial mixture before the non-siloxane-containing dihydroxy compound is added.

The initial interfacial mixture is then reacted by adding a first carbonate precursor to the mixture, causing the formation of carbonate linkages and the formation of a branched polychloroformate. Carbonate precursors include, for example, a carbonyl halide such as carbonyl bromide or carbonyl chloride, or a haloformate such as a bishaloformates of a dihydric phenol (e.g., the bischloroformates of bisphenol-A, hydroquinone, or the like) or a glycol (e.g., the bishaloformate of ethylene glycol, neopentyl glycol, polyethylene glycol, or the like). Combinations comprising at least one of the foregoing types of carbonate precursors may also be used. In exemplary embodiments, an interfacial polymerization reaction to form carbonate linkages uses phosgene as a carbonate precursor, and is referred to as a phosgenation reaction.

The first carbonate precursor may be added to the mixture at different addition rates or at more than one addition rate during polymerization. In embodiments, the first carbonate precursor is added in multiple additions to the mixture at more than one and less than five addition rates. Exemplary addition rates may be from about 0.01 to about 0.05 moles carbonate precursor/mole dihydroxy compound/minute. Generally, the interfacial mixture is reacted for a period of time ranging from about 5 minutes to about 60 minutes. While the interfacial mixture is reacted using the first carbonate precursor, the pH is maintained at from about 3 to about 9. A branched polychloroformate mixture results from the reaction of the interfacial mixture with the first carbonate precursor. The branched polychloroformate mixture will contain at least 1.5 mole percent of the polyhydric branching agent. The mole percent of the polyhydric branching agent is calculated based on the moles of the branching agent and the non-siloxane-containing dihydroxy compound only.

Next, the pH of the branched polychloroformate mixture is increased to a pH of from about 8 to about 13. A siloxane oligomer and a tertiary amine catalyst are also added to the branched polychloroformate mixture. These two steps can occur in either order, but generally the pH is increased first. The branched polychloroformate mixture is then reacted at the pH of about 8 to about 13 to form the branched polycarbonate-polysiloxane copolymer.

In some embodiments, the siloxane oligomer may be derived from silicon-containing dihydroxy compounds of formula (8):

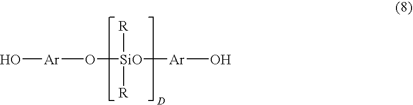

wherein D has an average value of 2 to 1,000; each R may independently be a C₁-C₁₃ alkyl group, C₁-C₁₃ alkoxy group, C₂-C₁₃ alkenyl group, C₂-C₁₃ alkenyloxy group, C₃-C₆ cycloalkyl group, C₃-C₆ cycloalkoxy group, C₆-C₁₄ aryl group, C₆-C₁₀ aryloxy group, C₇-C₁₃ arylalkyl group, C₇-C₁₃ arylalkoxy group, C₇-C₁₃ alkylaryl group, or C₇-C₁₃ alkylaryloxy group; and each Ar may independently be the same or different, and is a substituted or unsubstituted C₆-C₃₀ arylene radical, wherein the bonds are directly connected to an aromatic moiety. Useful Ar groups in formula (8) may be any monocyclic divalent aryl radical. Compounds of formula (8) may be obtained by the reaction of a dihydroxyarylene compound with, for example, an alpha, omega-bisacetoxypolydiorganosiloxane under phase transfer conditions.

In other embodiments, the siloxane oligomer may be derived from silicon-containing dihydroxy compounds of formula (9):

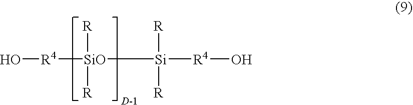

wherein R and D are as described above, and each occurrence of R⁴ is independently a divalent C₁-C₃₀ alkylene.

In still other embodiments, the siloxane oligomer may be derived from silicon-containing dihydroxy compounds of formula (10):

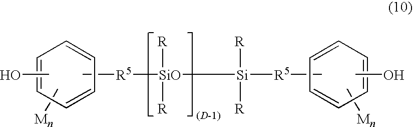

wherein R and D are as described above; each M may independently be cyano, nitro, C₁-C₈ alkylthio, C₁-C₈ alkyl, C₁-C₈ alkoxy, C₂-C₈ alkenyl, C₂-C₈ alkenyloxy, C₃-C₈ cycloalkyl, C₃-C₈ cycloalkoxy, C₆-C₁₀ aryl, C₆-C₁₀ aryloxy, C₇-C₁₂ arylalkyl, C₇-C₁₂ arylalkoxy, C₇-C₁₂ alkylaryl, or C₇-C₁₂ alkylaryloxy; each R⁵ is independently a divalent C₂-C₈ aliphatic group; and each n is independently an integer from 0 to 4. Such dihydroxy polysiloxanes can be made by effecting a platinum catalyzed addition between a siloxane hydride of formula (11):

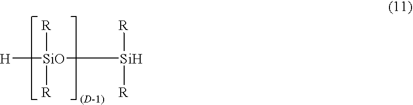

wherein R and D are as previously defined, and an aliphatically unsaturated monohydric phenol. Useful aliphatically unsaturated monohydric phenols included, for example, eugenol, 2-allylphenol, 4-allyl-2-methylphenol, 4-allyl-2-phenylphenol, 4-allyl-2-bromophenol, 4-allyl-2-t-butoxyphenol, 4-phenyl-2-phenylphenol, 2-methyl-4-propylphenol, 2-allyl-4,6-dimethylphenol, 2-allyl-4-bromo-6-methylphenol, 2-allyl-6-methoxy-4-methylphenol and 2-allyl-4,6-dimethylphenol. Mixtures comprising at least one of the foregoing may also be used.

In particular embodiments, M is selected from alkyl, alkoxy, or aryl; R⁵ is a dimethylene, trimethylene or tetramethylene group; and R is a C₁₋₈ alkyl or aryl. In other embodiments, R is methyl or a mixture of methyl and phenyl. In still other embodiments, M is methoxy, n is one, R⁵ is a divalent C₁-C₃ aliphatic group, and R is methyl.

It should be noted that the dihydroxy compound of the initial interfacial mixture contains no siloxane linkages. Thus, that dihydroxy compound is referred to as a non-siloxane-containing dihydroxy compound, in contrast to the siloxane oligomer added to the branched polycarbonate mixture.

The branched polychloroformate is reacted with the siloxane oligomer for a period of from about 5 minutes to about 20 minutes. A branched polycarbonate-polysiloxane copolymer results. The branched copolymer can be separated from the mixture using methods known in the art.

If desired, additional non-siloxane-containing dihydroxy compound, branching agent, endcapping agent, and catalyst may be added along with the siloxane oligomer. The branched polychloroformate mixture can then be further reacted by adding a second carbonate precursor as well while maintaining the pH at about 8 to about 13. Typically, the second carbonate precursor is the same as the first carbonate precursor.

The ratio of non-siloxane-containing dihydroxy compound to siloxane oligomer will partially affect several properties of the resulting branched copolymer. For example, ductility, impact strength, and flame retardance will all be affected. In embodiments, the siloxane oligomer is less than 8 weight percent of the branched polycarbonate-polysiloxane copolymer.

The resulting branched copolymer may contain at least 1.5 mole percent (mole %) of the polyhydric branching agent. In further embodiments, the branched copolymer contains 3 mole % or more of the polyhydric branching agent. In other embodiments, the branched copolymer contains from at least 1.5 to about 5 mole % of the polyhydric branching agent. Again, the mole percent of the polyhydric branching agent is calculated based on the moles of the branching agent and the non-siloxane-containing dihydroxy compound only; the endcapping agent and siloxane oligomer are excluded from this calculation. The branched copolymer may have a weight average molecular weight of about 20,000 or higher. The branched copolymer may have a polydispersity of about 4.0 or higher as well. The molecular weight can be measured by gas permeation chromatography (GPC) using polycarbonate standards.

The resulting branched polycarbonate-polysiloxane copolymer contains no halogens, is transparent, has improved flow properties, and/or has good flame retardance at thin wall thicknesses. The branched copolymer may have a haze level of 10 percent or less, including 5 percent or less, when measured according to ASTM D1003 and/or a melt viscosity of 210 Pa·sec when measured at 1500 sec^{—1} according to ISO 11443. An article molded from the branched copolymer can attain UL94 V₀ performance at a thickness of 1.5 millimeters or 1.0 millimeters. The resulting branched copolymer is also miscible and blendable with other polycarbonates.

Various additives ordinarily incorporated in resin compositions of this type may also be added to the polyestercarbonate as desired. Such additives include, for example, heat stabilizers; antioxidants; light stabilizers; plasticizers; antistatic agents; mold release agents; and blowing agents. Examples of heat stabilizers include triphenyl phosphite, tris-(2,6-dimethylphenyl)phosphite, tris-(2,4-di-t-butyl-phenyl) phosphite, tris-(mixed mono-and di-nonylphenyl)phosphite, dimethylbenzene phosphonate and trimethyl phosphate. Examples of antioxidants include octadecyl-3-(3,5-di-tert-butyl-4-hydroxyphenyl)propionate, and pentaerythrityl-tetrakis[3-(3,5-di-tert-butyl-4-hydroxyphenyl)propionate]. Examples of light stabilizers include 2-(2-hydroxy-5-methylphenyl)benzotriazole, 2-(2-hydroxy-5-tert-octylphenyl)-benzotriazole and 2-hydroxy-4-n-octoxy benzophenone. Examples of plasticizers include dioctyl-4,5-epoxy-hexahydrophthalate, tris-(octoxycarbonylethyl)isocyanurate, tristearin and epoxidized soybean oil. Examples of antistatic agents include glycerol monostearate, sodium stearyl sulfonate, and sodium dodecylbenzenesulfonate. Examples of mold releasing agents include pentaerythritol tetrastearate, stearyl stearate, beeswax, montan wax and paraffin wax.

Colorants may be added if desired. These include pigments, dyes, and quantum dots. The amount may vary as needed to achieve the desired color.

UV absorbers may be used. Exemplary UV absorbers include hydroxybenzophenones; hydroxybenzotriazoles; hydroxybenzotriazines; oxanilides; cyanoacrylates; benzoxazinones; or the like, or combinations comprising at least one of the foregoing UV absorbers.

Anti-drip agents may be included. Anti-drip agents may be, for example, a fibril forming or non-fibril forming fluoropolymer such as polytetrafluoroethylene (PTFE). The anti-drip agent may be encapsulated by a rigid copolymer as described above, for example styrene-acrylonitrile copolymer (SAN). PTFE encapsulated in SAN is known as TSAN. Encapsulated fluoropolymers may be made by polymerizing the encapsulating polymer in the presence of the fluoropolymer, for example an aqueous dispersion. TSAN may provide significant advantages over PTFE, in that TSAN may be more readily dispersed in the composition. A useful TSAN may comprise, for example, 50 wt % PTFE and 50 wt % SAN, based on the total weight of the encapsulated fluoropolymer. The SAN may comprise, for example, 75 wt % styrene and 25 wt % acrylonitrile based on the total weight of the copolymer. Alternatively, the fluoropolymer may be pre-blended in some manner with a second polymer, such as for, example, an aromatic polycarbonate resin or SAN to form an agglomerated material for use as an anti-drip agent. Either method may be used to produce an encapsulated fluoropolymer.

A salt-based flame retardant may be added. The flame retardant may be a K, Na, or Li salt. Useful salt-based flame retardants include alkali metal or alkaline earth metal salts of inorganic protonic acids and organic Bronstëd acids comprising at least one carbon atom. These salts should not contain chlorine and/or bromine. Preferably, the salt-based flame retardants are sulfonates. In specific embodiments, the salt-based flame retardant is selected from the group consisting of potassium diphenylsulfon-3-sulfonate (KSS), potassium perfluorobutane sulfonate (Rimar salt), and combinations comprising at least one of the foregoing. Other flame retardants include organic compounds that include phosphorus, bromine, and/or chlorine. Non-brominated and non-chlorinated phosphorus-containing flame retardants may be preferred in certain applications for regulatory reasons, for example organic phosphates and organic compounds containing phosphorus-nitrogen bonds. Inorganic flame retardants may also be used.

Combinations of any of the foregoing additives may be used. Such additives may be mixed in at a suitable time during the mixing of the components for forming the polyestercarbonate.

The branched polycarbonate-polysiloxane copolymers of the present disclosure may be formed into articles by conventional plastic processing techniques. Molded articles may be made by compression molding, injection molding or such molding techniques known to those skilled in the art. Such articles may include, but are not limited to, film, sheet, pipes, tubes, profiles, molded articles, preforms, stretch molded films and containers, injection molded containers, extrusion molded films and containers, thermoformed articles and the like. Articles prepared from the compositions of the present disclosure may be used in a wide variety of applications.

The following examples are provided to illustrate the branched polycarbonate-polysiloxane copolymers and methods of the present disclosure. The examples are merely illustrative and are not intended to limit the disclosure to the materials, conditions, or process parameters set forth therein.

### EXAMPLES

### Example 1

A 75 L glass reactor was equipped with condenser, agitator, pH probe, caustic and phosgene inlets, and a recirculation loop. Methylene chloride (4-8 L), water (11 L), bisphenol-A (1900 grams, 8.33 moles), 4-cyanophenol (44 grams, 0.369 moles), a solution of 1,1,1-tris(hydroxyphenyl)ethane (92 grams, 0.300 moles) dissolved in NaOH (50% w/w, 75 grams, 0.245 moles) and water (750 mL), an aqueous solution of methyl tributylammonium chloride (70% w/w, 36 grams, 0.107 moles), and sodium gluconate (10 grams) were added to the reactor.

Phosgene and NaOH were co-fed to the reactor; the NaOH was provided to maintain the reactor pH. A total of 1270 grams phosgene (12.84 moles) was added during phosgenation. The phosgene and NaOH were co-fed to the reactor at a rate of 80 grams/minute with a target phosgene/NaOH molar ratio of 2.40 and a target pH of 6.

After phosgenation, the reactor pH was increased to pH 10 using NaOH and the presence of chloroformates was confirmed by checking the reaction mixture with phosgene paper. A “reaction” sample of the chloroformate oligomer solution was obtained from the reactor for molecular weight determination; the sample had a weight average molecular weight of 3481 and a polydispersity index (PDI) of 1.96.

Next, a solution of D30 eugenol-capped siloxane (D30 is a bis-eugenol-capped siloxane with approximately 30 repeat units) fluid (300 grams, 0.118 moles) in methylene chloride (1 L) was added to the reactor. The reactor contents were then mixed for 10 minutes at pH of from 10 to 13. Additional bisphenol-A (1900 grams, 8.33 moles), methylene chloride (6 L), deionized water (7 L), and 4-cyanophenol (101 grams, 0.848 moles) were added to the reactor and the reactor contents were briefly stirred. A solution of triethylamine (35 mL, 25.4 grams, 0.251 moles) dissolved in methylene chloride (500 mL) was added to the reactor to complete the chloroformate condensation and the reactor pH was increased to 10 using NaOH.

Phosgene and NaOH were co-fed to the reactor a second time. A total of 912 grams phosgene (9.22 moles) was added during phosgenation. The phosgene and NaOH were co-fed to the reactor at a rate of 80 grams/minute with a target phosgene/NaOH molar ratio of 2.80 and a target pH of 9.

After completion of the second phosgenation step, the batch was sampled for molecular weight analyses, re-phosgenated (200 grams phosgene, 2.01 moles), and transferred to a centrifuge feed tank. The resultant solution of polymer in methylene chloride was isolated from brine, purified by acid wash to remove amine catalysts and further purified with subsequent water washes to remove brine and acid via centrifugation. The final polymer was isolated by steam precipitation and dried under a stream of hot nitrogen. The isolated product had a Mw of 31986 and PDI of 4.17, 1.8 mole % THPE, and 6% siloxane linkages.

### Example 2

A 75 L glass reactor was equipped with condenser, agitator, pH probe, caustic and phosgene inlets, and a recirculation loop. Methylene chloride (8 L), water (11 L), bisphenol-A (1900 grams, 8.33 moles), 4-cyanophenol (44 grams, 0.369 moles), a solution of 1,1,1-tris(hydroxyphenyl)ethane (92 grams, 0.300 moles) dissolved in NaOH (50% w/w, 75 grams, 0.245 moles) and water (750 mL), an aqueous solution of methyl tributylammonium chloride (70% w/w, 36 grams, 0.107 moles), and sodium gluconate (10 grams) were added to the reactor.

Phosgene and NaOH were co-fed to the reactor; the NaOH was provided to maintain the reactor pH. A total of 1270 grams phosgene (12.84 moles) was added during phosgenation. The phosgene and NaOH were co-fed to the reactor at a rate of 80 grams/minute with a target phosgene/NaOH molar ratio of 2.40 and a target pH of 6.

After phosgenation, the reactor pH was increased to pH 10 using NaOH and the presence of chloroformates was confirmed by checking the reaction mixture with phosgene paper. A “reaction” sample of the chloroformate oligomer solution was obtained from the reactor for molecular weight determination; the sample had a weight average molecular weight of 3965 and a polydispersity index (PDI) of 2.39.

Next, a solution of D30 eugenol-capped siloxane fluid (300 grams, 0.118 moles) in methylene chloride (1 L) was added to the reactor. The reactor contents were then mixed for 10 minutes at pH 10-13. Additional bisphenol-A (1900 grams, 8.33 moles), methylene chloride (6 L), deionized water (7 L), and 4-cyanophenol (111 grams, 0.932 moles) were added to the reactor and the reactor contents were briefly stirred. A solution of triethylamine (35 mL, 25.4 grams, 0.251 moles) dissolved in methylene chloride (500 mL) was added to the reactor to complete the chloroformate condensation and the reactor pH was increased to 9 using NaOH.

Phosgene and NaOH were co-fed to the reactor a second time. A total of 912 grams phosgene (9.22 moles) was added during phosgenation. The phosgene and NaOH were co-fed to the reactor at a rate of 80 grams/minute with a target phosgene/NaOH molar ratio of 2.80 and a target pH of 9.

After completion of the second phosgenation step, the batch was sampled for molecular weight analyses, re-phosgenated (400 grams phosgene, 4.02 moles), and transferred to a centrifuge feed tank. The resultant solution of polymer in methylene chloride was isolated from brine, purified by acid wash to remove amine catalysts and further purified with subsequent water washes to remove brine and acid via centrifugation. The final polymer was isolated by steam precipitation and dried under a stream of hot nitrogen. The isolated product had Mw of 29353 and PDI of 4.02, 1.8 mole % THPE, and 6% siloxane linkages.

### Example 3

A 75 L glass reactor was equipped with condenser, agitator, pH probe, caustic and phosgene inlets, and a recirculation loop. Methylene chloride (8 L), water (11 L), bisphenol-A (1900 grams, 8.33 moles), 4-cyanophenol (44 grams, 0.369 moles), a solution of 1,1,1-tris(hydroxyphenyl)ethane (154 grams, 0.503 moles) dissolved in NaOH (50% w/w, 125 grams, 0.245 moles) and water (750 mL), an aqueous solution of methyl tributylammonium chloride (70% w/w, 36 grams, 0.107 moles), and sodium gluconate (10 grams) were added to the reactor.

Phosgene and NaOH were co-fed to the reactor; the NaOH was provided to maintain the reactor pH. A total of 1270 grams phosgene (12.84 moles) was added during phosgenation. The phosgene and NaOH were co-fed to the reactor at a rate of 80 grams/minute with a target phosgene/NaOH molar ratio of 2.40 and a target pH of 6.

After phosgenation, the reactor pH was increased to pH 9 using NaOH and the presence of chloroformates was confirmed by checking the reaction mixture with phosgene paper. A “reaction” sample of the chloroformate oligomer solution was obtained from the reactor for molecular weight determination; the sample had a weight average molecular weight of 4932 and a polydispersity index (PDI) of 2.95.

Next, a solution of D30 eugenol-capped siloxane fluid (300 grams, 0.118 moles) in methylene chloride (1 L) was added to the reactor. The reactor contents were then mixed for 10 minutes at pH 10-13. Additional bisphenol-A (1900 grams, 8.33 moles), methylene chloride (6 L), deionized water (7 L), and 4-cyanophenol (150 grams, 1.26 moles) were added to the reactor and the reactor contents were briefly stirred. A solution of triethylamine (35 mL, 25.4 grams, 0.251 moles) dissolved in methylene chloride (500 mL) was added to the reactor to complete the chloroformate condensation and the reactor pH was increased to 9 using NaOH.

Phosgene and NaOH were co-fed to the reactor a second time. A total of 912 grams phosgene (9.22 moles) was added during phosgenation. The phosgene and NaOH were co-fed to the reactor at a rate of 80 grams/minute with a target phosgene/NaOH molar ratio of 2.80 and a target pH of 9.

After completion of the second phosgenation step, the batch was sampled for molecular weight analyses, re-phosgenated (200 grams phosgene, 2.01 moles), and transferred to a centrifuge feed tank. The resultant solution of polymer in methylene chloride was isolated from brine, purified by acid wash to remove amine catalysts and further purified with subsequent water washes to remove brine and acid via centrifugation. The final polymer was isolated by steam precipitation and dried under a stream of hot nitrogen. The isolated product had a Mw of 41988 and PDI of 6.31, 3 mole % THPE, and 6% siloxane linkages.

### Testing

The branched polycarbonate-polysiloxane copolymers of Examples 1-3 were then mixed with 0.25 parts per hundred parts resin (phr) of mold release agent pentaerythritol tetrastearate (PETS) obtained from FACI Fasco-Genova Italy, 0.06 phr IRGAFOS® 168 antioxidant from Ciba Specialty Chemicals, 0.08-0.1 phr potassium nonafluorobutylsulfonate flame retardant from 3M, and 0.05 phr octaphenylcyclotetrasiloxane flame retardant from Momentive Performance Materials. The formulations were extruded on a twin-screw extruder and injection molded into test articles.

As a Comparative Example, a formulation was made with a bisphenol-A homopolycarbonate having a Mw of 26,500 available from SABIC Innovative Plastics.

Mechanical properties were measured according to the following standards, as indicated:

| | Standards | Testing Conditions |
|---|---|---|
| Melt Volume Rate | ISO 1133 | 300° C., 1.2 kg weight |
| Weight Average Molecular | | GPC with reference to |
| weight | | polycarbonate standards |
| Polydispersity Index | | GPC with reference to |
| | | polycarbonate standards |
| Melt Viscosity | ISO 11443 | 1500 sec⁻¹ |
| Instrumental Impact Ductility | ASTM D3763 | 23° C. |
| Haze | ASTM D1003 | |

Flammability tests were performed following the procedure of Underwriter's Laboratory Bulletin 94 entitled “Tests for Flammability of Plastic Materials, UL94.” Several ratings can be applied based on the rate of burning, time to extinguish, ability to resist dripping, and whether or not drips are burning. According to this procedure, materials can be classified as UL94 HB, V0, V1, V2, 5VA, and/or 5VB on the basis of the test results obtained for five samples. The criteria for each of these flammability classifications are described below.

HB: In a 5-inch sample, placed so that the long axis of the sample is horizontal to the flame, the rate of burn of the sample is less than 3 inches per minute, and the flame is extinguished before 4 inches of sample are burned.

V0: In a sample placed so that its long axis is 180 degrees to the flame, the average period of flaming and/or smoldering after removing the igniting flame does not exceed ten seconds and none of the vertically placed samples produces drips of burning particles that ignite absorbent cotton. Five bar flame out time (FOT) is the sum of the flame out time for five bars, each lit twice for a maximum flame out time of 50 seconds.

V1: In a sample placed so that its long axis is 180 degrees to the flame, the average period of flaming and/or smoldering after removing the igniting flame does not exceed twenty-five seconds and none of the vertically placed samples produces drips of burning particles that ignite absorbent cofton. Five bar flame out time is the sum of the flame out time for five bars, each lit twice for a maximum flame out time of 250 seconds.

V2: In a sample placed so that its long axis is 180 degrees to the flame, the average period of flaming and/or smoldering after removing the igniting flame does not exceed twenty-five seconds, but the vertically placed samples produce drips of burning particles that ignite cotton. Five bar flame out time is the sum of the flame out time for five bars, each lit twice for a maximum flame out time of 250 seconds.

Table 1 summarizes the properties of the Examples.

TABLE 1

| | | | | Melt | | UL rating | UL rating | | Chloride |
|---|---|---|---|---|---|---|---|---|---|
| | MVR | | | Viscosity | Ductility | at 1.5 mm | at 1.0 mm | | Content |
| Example | (g/10 min) | Mw | PDI | (Pa · sec) | (%) | thickness | thickness | Haze | (ppm) |
| 1 | 9.3 | 32,000 | 4.2 | 190.1 | 100 | V0 | V2 | 6.9 | 0.41 |
| 2 | 12.3 | 29,400 | 4.0 | 170.8 | 100 | V0 | V2 | 3.8 | 0.76 |
| 3 | 10.4 | 42,000 | 6.3 | 203.7 | 100 | V0 | V0 | 8.5 | 0.46 |
| Comparative | 11 | 26,500 | 2.3 | 253.1 | 100 | V2 | V2 | | |

Examples 1-3 had better flame retardance than the Comparative Example at 1.5 mm thickness, and Example 3 obtained V0 performance at 1.0 mm thickness. In addition, Examples 1-3 had a lower melt viscosity (lower melt viscosity means improved flow).

The branched polycarbonate-polysiloxane copolymers and processes of the present disclosure have been described with reference to exemplary embodiments. Obviously, modifications and alterations will occur to others upon reading and understanding the preceding detailed description. It is intended that the exemplary embodiments be construed as including all such modifications and alterations insofar as they come within the scope of the appended claims or the equivalents thereof.

1. A method for making a branched polycarbonate-polysiloxane copolymer, comprising:
forming an interfacial mixture comprising water, a substantially water-immiscible organic solvent, a polyhydric branching agent, a non-siloxane-containing dihydroxy compound, an endcapping agent, a phase transfer catalyst, and a base, wherein the base and the branching agent are dissolved in the mixture before the non-siloxane-containing dihydroxy compound is added to the mixture and wherein the interfacial mixture has a basic pH;
reacting the interfacial mixture by adding a first carbonate precursor to the interfacial mixture while maintaining the pH at from about 3 to about 9 to form a branched polychloroformate mixture containing at least 1.5 mole percent of the polyhydric branching agent;
increasing the pH to from about 8 to about 13 and adding a siloxane oligomer and a tertiary amine catalyst to the branched polychloroformate mixture;
reacting the branched polychloroformate mixture; and
optionally adding a second carbonate precursor to the branched polychloroformate mixture while maintaining the pH at about 8 to about 13 during the reacting of the branched polychloroformate mixture;
to form the branched polycarbonate-polysiloxane copolymer, wherein the copolymer contains 20 ppm or less of residual chloride.

2. The method of claim 1, wherein the organic solvent is methylene chloride or a chlorine-containing aromatic solvent.

3. The method of claim 1, wherein the polyhydric branching agent is selected from the group consisting of 1,1,1-tris(4-hydroxyphenyl)ethane, 1,3,5-tris(4-hydroxyphenyl)benzene, tris(4-hydroxyphenyl)methane, 1,1,2-tris(4-hydroxyphenyl)propane, 1,3,5-trihydroxybenzene, m-terphenyltriol, trisphenol PA, 1,3,5-tris((4-hydroxyphenyl)isopropyl)benzene, and 1,1,1-tris(3-methyl-4-hydroxyphenyl)ethane.

4. The method of claim 1, wherein the dihydroxy compound is bisphenol-A.

5. The method of claim 1, wherein the endcapping agent is 4-cyanophenol, p-cumyl phenol, phenol, or 4-t-butylphenol.

6. The method of claim 1, wherein the phase transfer catalyst is methyltributylammonium chloride.

7. The method of claim 1, wherein the tertiary amine catalyst is triethylamine.

8. The method of claim 1, wherein the carbonate precursor is phosgene.

9. The method of claim 1, wherein the first carbonate precursor is added to the mixture at more than one and less than five addition rates.

10. The method of claim 1, wherein the branched polycarbonate-polysiloxane copolymer contains at least 3 mole percent of the polyhydric branching agent.

11. The method of claim 1, wherein the branched polycarbonate-polysiloxane copolymer has a weight average molecular weight of about 20,000 or higher.

12. The method of claim 1, wherein the branched polycarbonate-polysiloxane copolymer has a melt viscosity of 210 Pa·sec or lower when measured at 1500 sec⁻¹ according to ISO 11443.

13. The method of claim 1, wherein the branched polycarbonate-polysiloxane copolymer has a haze level of 10 percent or less when measured according to ASTM D1003.

14. The method of claim 1, wherein an article molded from the branched polycarbonate-polysiloxane copolymer can attain UL94 V0 performance at a thickness of 1.5 millimeters.

15. The method of claim 1, wherein an article molded from the branched polycarbonate-polysiloxane copolymer can attain UL94 V0 performance at a thickness of 1.0 millimeters.

16. The method of claim 1, further comprising separating the branched polycarbonate-polysiloxane copolymer from the interfacial mixture.

17. The branched polycarbonate-polysiloxane copolymer formed by the method of claim 1.

18. A branched polycarbonate-polysiloxane copolymer having a weight average molecular weight of 28,000 or higher and a melt viscosity of 210 Pa·sec or lower when measured at 1500 sec⁻¹ according to ISO 11443.

19. The copolymer of claim 18, wherein the branched polycarbonate-polysiloxane copolymer has a haze level of 10 percent or less when measured according to ASTM D1003.

20. The copolymer of claim 18, wherein the branched polycarbonate-polysiloxane copolymer has a haze level of 5 percent or less when measured according to ASTM D1003.

21. A branched polycarbonate-polysiloxane copolymer produced by the process comprising:
forming an interfacial mixture comprising water; a substantially water-immiscible organic solvent; a polyhydric branching agent selected from the group consisting of 1,1,1-tris(4-hydroxyphenyl)ethane, 1,3,5-tris(4-hydroxyphenyl)benzene, tris(4-hydroxyphenyl)methane, 1,1,2-tris(4-hydroxyphenyl)propane, 1,3,5-trihydroxybenzene, m-terphenyltriol, trisphenol PA, 1,3,5-tris((4-hydroxyphenyl)isopropyl)benzene, and 1,1,1-tris(3-methyl-4-hydroxyphenyl)ethane; bisphenol A; an endcapping agent selected from the group consisting of 4-cyanophenol, p-cumyl phenol, phenol, and 4-t-butylphenol, a phase transfer catalyst; and, a base, wherein the base and the branching agent are dissolved in the mixture before the bisphenol A is added to the mixture and wherein the interfacial mixture has a basic pH;
reacting the interfacial mixture by adding a phosgene to the interfacial mixture while maintaining the pH at from about 3 to about 9 to form a branched polychloroformate mixture containing at least 1.5 mole percent of the polyhydric branching agent;
increasing the pH to from about 8 to about 13 and adding a siloxane oligomer and a tertiary amine catalyst to the branched polychloroformate mixture;
reacting the branched polychloroformate mixture; and
optionally adding a second carbonate precursor to the branched polychloroformate mixture while maintaining the pH at about 8 to about 13 during the reacting of the branched polychloroformate mixture;
to form the branched polycarbonate-polysiloxane copolymer, wherein the copolymer contains 20 ppm or less of residual chloride.
